(19) United States
(12) Patent Application Publication
(10) Pub. No.: US 2008/0243651 A1
(43) Pub. Date: Oct. 2, 2008

(54) Method for Acquiring and Maintaining High Quality Subscribers Using a Bifurcated Contract

(75) Inventor: Richard S. Zizian, San Diego, CA (US)

Correspondence Address: REINHART BOERNER VAN DEUREN P.C., 2215 PERRYGREEN WAY, ROCKFORD, IL, 61107, US

(73) Assignee: SAG ACCEPTANCE COMPANY, LLC, Mequon, WI (US)

(21) Appl. No.: 11/694,444

(22) Filed: Mar. 30, 2007

(51) Int. Cl. G06F 19/00

(52) U.S. Cl. 705/30

(57) ABSTRACT

A method to provide an enterprise with the ability to keep service contract subscribers for a longer period of time and the ability to retain subscribers during an initial period of time is presented. A bifurcated contract is used with the subscriber for the agreement. The bifurcated contract consists of a service portion and a financial installment portion to pay for the hardware, certain service costs and installation costs associated with the service. The financing portion allows the subscriber's credit rating to be affected and affords the enterprise greater collateral or security as well as potentially lower funding costs. The enterprise encourages the vendor that originated the contract to sell the contract by paying the vendor the vendor's cost and a portion of the typical vendor profit along with, in certain cases, a percentage of the monthly payments for those subscribers retaining the service beyond an initial term.

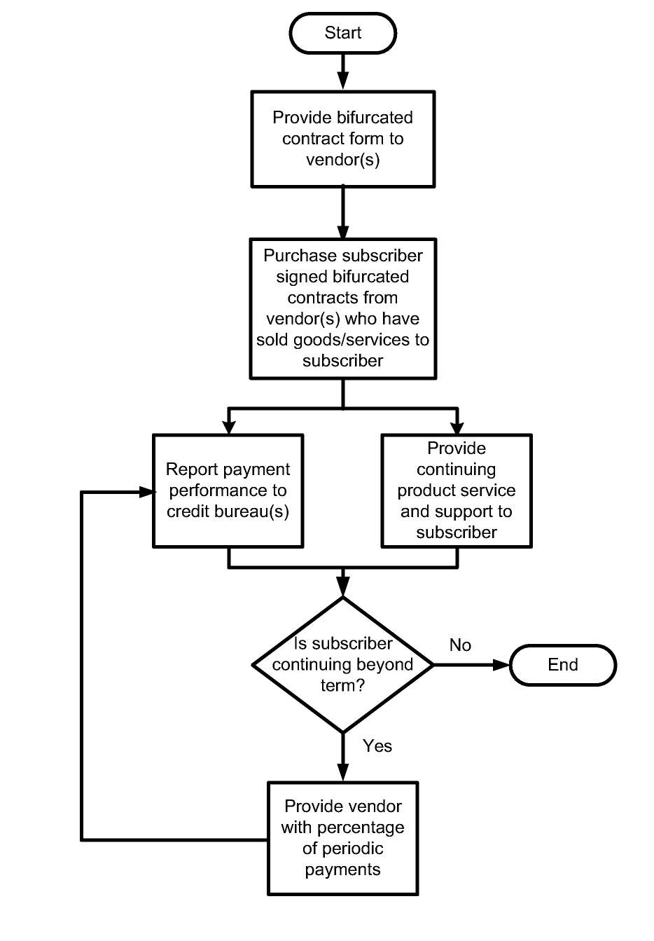

### BACKGROUND

A subscriber is an individual consumer or a commercial business who purchases periodic services. High quality subscriber relationships are the backbone of many service oriented businesses as high-quality subscribers retain their service relationship with an enterprise for long periods of time. In some service oriented business relationships, the high quality subscribers sign an initial contract for services for a period of time (“periodic services”) and then maintain a continuing relationship with the service provider for an extended period of time after the initial periodic contract term. As a result, an industry has developed to help enterprises keep their high quality subscribers.

Some enterprises, however, have been designed to buy the initial subscriber contracts from the vendor that originated and owns the initial subscriber relationship, and take over the service portion of the initial contract. If the subscriber continues paying for and receiving the service being provided beyond the term of the initial contract, the enterprise benefits from a more profitable relationship. For subscribers who do not stay with the service, the enterprise's profit, if any, is reduced and may even be negative, resulting in a charge-off. For example, in the alarm service industry, there are many small local alarm system dealers (i.e., a vendors) that install alarm systems with the consumer signing a long-term contract for the alarm monitoring service. Enterprises buy the contract for the monitoring service, paying the vendor for the subscriber contract and a portion of the vendor's anticipated profit. The enterprise that has purchased the contract and the subscriber relationship then provides the monitoring service and collects the payments from the subscriber for the remainder of the relationship, which may extend beyond the initial term of the contract. For subscribers who continue paying for and receiving the monitoring service for longer than the initial contract term, the enterprise that maintains the monitoring service improves its profitability. Subscribers who do not stay with the monitoring service (e.g., by canceling the service, by changing to a different service provider, etc.) are detrimental to the enterprise.

### BRIEF SUMMARY

Provided is a method that enhances an enterprise's ability to keep subscribers that are high quality subscribers (i.e. subscribers who typically keep a service beyond the initial term of a service contract) and enhances the enterprise's ability to retain all subscribers through the initial term of the service contract.

A bifurcated contract is used with the subscriber for the initial agreement. The bifurcated contract consists of two interrelated but inseparable parts, which together constitute the entire agreement. The first part relates to the service provided and the second part provides the financing for the goods and other costs provided for the service. The financing part of the agreement allows the subscriber's credit rating to be adversely affected if the subscriber is late making payments or is in default. The financing part of the agreement may also provide additional security or collateral not available in a standard subscriber service agreement.

The enterprise encourages the vendor to sell the contract by paying the vendor the vendor's cost and a portion of a typical vendor profit along with, in certain circumstances, a percentage of the monthly payments for those subscribers that retain the service beyond an initial term.

Other aspects, objectives and advantages of the invention will become more apparent from the following detailed description when taken in conjunction with the accompanying drawings.

### BRIEF DESCRIPTION OF THE DRAWING

The FIGURE is a flow chart illustrating the steps the present invention performs.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

The method provided herein allows an enterprise (e.g., a company, a business) to acquire and maintain high quality subscribers from other vendors in service industries that involve the use of hardware. In the description that follows, an alarm system vendor shall be used to describe the features of the invention with the understanding that the features can be used in other industries. Many vendors use contracts for at least the initial period of time in which the service is provided. In the service industry, high quality subscribers are subscribers that keep their service well beyond the term of the initial contract. Such subscribers also generally have a good credit rating.

Turning now to the drawing, the enterprise determines if a potential subscriber is a subscriber who will typically keep a service beyond the initial term of a service contract. If the enterprise considers the subscriber is likely to be a high quality subscriber, the enterprise “acquires” the contract and the subscriber relationship from vendors, e.g., businesses such as retailing businesses of hardware that requires special services to make the hardware achieve the expected benefit, by paying the vendor for the contract. The payment is for any goods (including but not limited to, hardware, installation and warranty) provided with the service, the rights to provide the service in the future and a portion of the typical business profit. The enterprise then provides the service and collects the periodic payments (e.g., monthly payments) from the subscriber for the term of the contract. In one embodiment, the enterprise reports the payment performance to credit bureaus due to debtor/creditor aspect of the contractual relationship with the subscriber. To encourage the vendor to sell the contract, the enterprise may additionally agree to provide the vendor with a percentage of the periodic payment for those subscribers that retain the service beyond an initial term.

For example, most alarm systems are installed by small, local vendors that cannot afford to provide their own financing. Typically, the vendor provides and installs the alarm system for a subscriber for little or no up-front payment, with the subscriber signing a long-term contract for the monitoring service (e.g., typically 24 to 60 months prior to renewals). The vendor sells the contract to the enterprise (which in this example would be an alarm company), which pays the vendor for the contract and the subscriber relationship plus a portion of the typical vendor profit and then provides the service and collects the payments from the subscriber for the term of the contract (e.g., 24 to 60 months during the initial term prior to renewals). The alarm company additionally agrees to provide the vendor with a percentage (10%, for example) of the monthly payments for those subscribers that retain the alarm service through the alarm company beyond an initial term. This incentive is in exchange for providing field service (for which the vendor may charge the subscriber) and should be sufficient to convince vendors to sell their contracts to the alarm company. This is a win-win deal, because both the alarm company and the vendor have something to gain—the alarm company gets more contracts from the vendor and increases its probability of profitable, high quality subscribers, and the vendors share the long-term profits from high quality subscribers that continue the service beyond the initial term of the contracts.

Instead of a typical contract (e.g. a service contract), a bifurcated contract is used with the subscriber. A bifurcated contract is a single contract with a subscriber consisting of two interrelated but inseparable parts. The first part relates to the provision of the service and typically has automatic renewal provisions. The second part provides financing of the goods, certain continuing services and/or installation costs required for the service with a licensed financing company. As an example, using the alarm service of the previous example, the first part of the bifurcated contract would relate to the provision of security alarm monitoring services, and the second part would provide financing of the security hardware, installation cost, and standard or special monitoring services for the initial term (e.g., 24, 36, 48, or 60 months) of the contract.

The payments on the second part are mandatory for the initial term and are non-cancelable, although the agreement may be terminated early by paying off the contract in full. The transaction between the vendor and the subscriber contemplates a long-term relationship from inception, with the mutual intent and understanding that the business relationship is designed to survive and continue beyond the initial term as demonstrated by the automatic renewal provisions, which typically are for a like-term, dependent upon applicable law. In the alarm monitoring service industry, for example, this is supported by the fact that on average eighty percent (80%) of alarm service subscribers remain as active, paying subscribers for an additional 3 to 12 years beyond the initial term of their agreements as indicated by alarm industry performance statistics.

The use of the bifurcated contract provides several advantages over a traditional service contract. One of the advantages of the bifurcated contract is that the second part of the bifurcated contract is a loan and its performance, delinquency and default rates are measured as an installment loan. As such, it is a mandatory legal obligation of the consumer. It provides no voluntary walk away rights to the subscriber, only an early termination right by paying off the outstanding balance in full. A traditional service contract, on the other hand, is not a loan or a financial instrument. It is a service agreement to provide a future executory service. The charge off rate can range from 1 to 10% per year, or higher, due to the fact that it lacks the psychological, credit-reporting and long-term enforceability attributes of the bifurcated contract as discussed below.

The second advantage relies on the fact that a vast majority of subscribers understand the legal ramifications of purchasing goods and services by taking out a loan, whether on a direct loan, installment finance contract, revolving credit or credit card basis. A subscriber's life experience makes a subscriber understand the legal ramification and consequences for non-performance of these types of financial instruments. Conversely, a majority of subscribers who purchase services (e.g., an alarm system and monitoring service) using traditional service contracts (e.g., a monitoring contract), have little or no knowledge or experience with the concept of an executory service agreement, nor understand the rights, duties or responsibilities of the relationship because it is a hybrid agreement compared to typical transactions which subscribers are used to completing.

With a bifurcated contract, a subscriber receives the federal truth-in-lending disclosures (i.e., Federal Regulation Z disclosures), if required, with term, interest rate, total of payments, total cash price, monthly payment, etc. that the subscriber expects to see on a legally binding contract and loan obligation. As such, the second advantage is that the subscriber's payment performance qualifies to be reported to the national credit bureaus on a monthly basis as the bifurcated contract is a credit instrument transaction with a licensed finance company. This is a significant psychological performance enhancing factor with the subscriber. The subscriber will psychologically know they signed a “loan” to purchase the goods/installation costs/etc. associated with the service. Additionally, many subscribers now expect that their payment performance will be reported to the credit bureau(s) because the payment is a loan payment. As a result, the psychological impact of taking out a loan is present in the bifurcated contract. This is not necessarily so on the traditional service agreement. The psychological commitment to the traditional service agreement process is typically far less than that of the bifurcated contract.

High quality subscribers and the maintenance of a good credit score are very synonymous. A decade ago no one talked about credit scores and not many subscribers were aware of or knew the importance of the credit score. As more and more industries that impact subscriber buying power focus on the credit score as the “qualification system”, subscribers have become much more aware of the importance of their credit score and how a bad credit score can affect their lives, their businesses and buying power. Today, for example, the internet, radio and television frequently advertise credit services and the importance of a good credit score. Using the bifurcated contract allows the subscriber's consumer's performance on the contract to be reported to the credit bureau on a monthly basis. Subscribers who elect to default on their contracts will therefore be exposed to a negative credit rating, which can be immediately reported on their credit with the default potentially continuing to be reported for up to seven years after the default. Since many services have a low cost, many consumers will likely elect not to default once they realize the impact such a default would have on their credit scores. Conversely, the bifurcated contracts allows for the reporting of the timely and positive (As Agreed) performance of high quality subscribers to the national credit bureaus. Non-credit, traditional service agreements are not typically reported to the credit bureaus and may not be an eligible class of business for subscriber reporting purposes.

A further advantage of using the bifurcated contract is that as a financial instrument, it can take priority over second mortgages. If the vendor has mechanic's lien rights within his jurisdiction, those rights may be transferable to the purchasing enterprise in some states, which enhances the enforceability of the bifurcated contract.

One industry where the bifurcated contact can be used is in the security alarm industry. The upfront cost of many subscriber residential alarm systems, which are often installed by small, local dealers (vendors), have an initial cost of less than $1,500 in most cases and have a periodic monthly cost to the subscriber of less than $50. As a result, the initial balance of the bifurcated contract would be less than $1,500 and the monthly payment in the discretionary income range, it is believed that the vast majority of subscribers who default will elect to payoff their balances or elect not to default in the first place once they realize the impact the bifurcated contract transaction will have on their credit score and buying power for the next seven years.

Additionally, the bifurcated contract may provide lower funding costs to the alarm company through the use of securitization or other funding techniques normally used in the financial instruments markets that may not be used in the service agreement financing markets. Another unique feature of the bifurcated contract is that the first part of the bifurcated contract, which runs in parallel with the second part from inception, continues on and survives the term of the retail installment portion of the contract (i.e., the second part). The durability of the need for the service by the subscriber can historically validate the post-installment loan portion of the revenue stream. When the payments for the second part of the contract are completed (i.e., the last contractual installment payment), the service being provided in many service industries is still desired and necessary to supply to the subscriber to meet the initial and continuing needs of the subscriber. The pay-off of the second part is designed to be a seamless transition upon the maturity of the installment loan and the continuation of first part of the contract. Assuming that the subscriber's service experience and expectations during the initial term of the contract were in order, there is no apparent reason for the subscriber to not continue the relationship. Many subscribers will not make the mental transition from a loan payment to a monthly service payment in for example, month 25, 37, 49 or 61. Instead it is a seamless continuation of the monthly fees for the necessary services to keep the service performing the way the subscriber originally contemplated.

For example, in the alarm service industry, the durability of the need for monitoring services by the subscriber will generally validate the post-installment loan revenue stream assumption. When the payments for the second part of the contract are completed, the monitoring support service is still desired and necessary to supply the subscriber with the central station/police/fire and medical emergency response signals transmitted from the security system, which is now owned by the subscriber. Assuming that the subscriber's service experience and expectations during the initial term of the contract were in order, there is no apparent reason for the subscriber to not continue the alarm monitoring service.

Note that in an embodiment, pools of contracts that were originated by vendors can be purchased by the enterprise in bulk using the methodology described herein. The vendors can use conventional contracts or preferably, the bifurcated contract described herein.

Note that the steps of the method can be performed by a computing device having a processor such as for example, a processor in a computer. For example, determining if a consumer is a high quality consumer may be done with a processor, reporting payment performance to a credit bureau may be done with a processor, etc. The processor executes computer-executable instructions, such as program modules. Generally, program modules include routines, programs, objects, components, data structures, etc. that perform particular tasks or implement particular abstract data types. Moreover, those skilled in the art will appreciate that the processor may be implemented in computer system configurations, including hand-held devices, multi-processor systems, microprocessor based or programmable consumer electronics, network PCs, minicomputers, mainframe computers, and the like.

In its most basic configuration, the processor interfaces with a memory. Depending on the exact configuration and type of computing device, the memory may be volatile (such as RAM), non-volatile (such as ROM, flash memory, etc.) or some combination of the two. Additionally, the computing device in which the processor is implemented may also have additional features/functionality. For example, there may also be additional storage (removable and/or non-removable) including, but not limited to, magnetic or optical disks or tapes. Computer storage media includes volatile and nonvolatile, removable and non-removable media implemented in any method or technology for storage of information such as computer readable instructions, data structures, program modules or other data. The memory, the removable storage and the non-removable storage are all examples of computer storage media. Computer storage media includes, but is not limited to, RAM, ROM, EEPROM, flash memory or other memory technology, CDROM, digital versatile disks (DVD) or other optical storage, magnetic cassettes, magnetic tape, magnetic disk storage or other magnetic storage devices, or any other medium which can be used to store the desired information and which can accessed by the processor.

From the foregoing, it can be seen that a method to provide an enterprise with the ability to keep subscribers that are high quality subscribers has been described. A bifurcated contract is used with the subscriber for the agreement. The bifurcated contract consists of a service portion and a financial installment portion to pay for the hardware associated with the service. The financing portion allows the subscriber's credit rating to be affected. The enterprise encourages the initial vendor to sell the contract by paying the vendor the vendor's cost and a portion of the typical vendor profit along with a percentage of the monthly payments for those subscribers that retain the service beyond an initial term.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for acquiring subscribers who have a higher probability of retaining and paying for a service for longer than an initial term of a service agreement, the steps comprising:
creating contractual arrangements that mirror the economic transactions that service providers transact with subscribers that result in periodic payments;
and incorporating a bifurcated contract into the contractual arrangements, the bifurcated contract having a service portion defining the services to be provided by an enterprise and the payments to be made by the subscriber over the life of the relationship and an installment loan portion which provides financing for hardware purchases, select services or installation costs associated with the service.

2. The method of claim 1 further comprising the step of reporting payment performance of the subscriber to at least one credit bureau.

3. The method of claim 1 further comprising the step of determining if the subscriber is likely to stay with the service longer than the initial term.

4. The method of claim 3 wherein the step of determining if the subscriber is likely to stay with the service longer than the initial term comprises the steps of:
determining if the subscriber has a credit rating above a predetermined value;
if the credit rating is above the predetermined value, determining that the subscriber has the potential to stay with the service longer than the initial term.

5. The method of claim 4 wherein the step of determining if the subscriber has a credit rating above a predetermined value comprises the step of determining if the subscriber has a credit rating above a prescribed level as determined by an analysis, the analysis including an analysis of credit information, collateral, and the industry or service to be provided.

6. The method of claim 3 further comprising the step of determining that the subscriber is not likely to stay with the service longer than the initial term if the credit rating is below a second predetermined value.

7. The method of claim 1 wherein the service is an alarm service.

8. A method for acquiring a subscriber and ensuring the subscriber has a higher probability of retaining and paying for a service during an initial term of a service agreement, the steps comprising:
having the subscriber sign a bifurcated contract to initiate the service, the bifurcated contract having a first portion for providing the service and a second portion for financing the hardware and installation associated with the service; and
reporting payment performance of the subscriber to at least one credit bureau.

9. The method of claim 8 further comprising the steps of:
if the subscriber has signed the contract with a vendor:
determining if the subscriber is likely to stay with the service longer than the initial term;
if the subscriber is likely to stay with the service longer than the initial term:
acquiring the contract from the vendor; and
providing the vendor a portion of payments made by the subscriber beyond the initial term.

10. The method of claim 9 wherein the step of acquiring the contract from the vendor comprises the step of paying the vendor for the vendor's cost and a portion of future profits.

11. The method of claim 9 wherein the vendor has a pool of contracts with a plurality of subscriber, the method further comprising the steps of:
acquiring the pool of contracts from the vendor; and
providing the vendor a portion of payments made by the plurality of subscribers for those subscribers that keep the service beyond the initial term.

12. A computer readable medium having computer executable instructions for acquiring ensuring a subscriber has a higher probability of retaining and paying for a service during an initial term of a service agreement, the service having hardware that is installed as part of the service, the computer executable instructions, when executed, performing the steps comprising:
reporting payment performance of the subscriber to at least one credit bureau if the subscriber signs a bifurcated contract to initiate the service, the bifurcated contract having a first portion for providing the service and a second portion for financing the hardware associated with the service.

13. The computer readable medium of claim 12 having further computer executable instructions, that when executed, perform the step comprising determining if the subscriber is likely to stay with the service longer than the initial term.

14. The computer readable medium of claim 13 wherein the step of determining if the subscriber is likely to stay with the service longer than the initial term comprises the steps of:
determining if the subscriber has a credit rating above a predetermined value; and
if the credit rating is above the predetermined value, determining that the subscriber is likely to stay with the service longer than the initial term.

15. The computer readable medium of claim 12 having further computer executable instructions, that when executed, perform the step comprising:
providing a vendor a portion of payments made by the subscriber beyond the initial term if the subscribe signed a contract with the vendor for contracts acquired from the vendor.
